(19) United States
(12) Patent Application Publication
(10) Pub. No.: US 2016/0149402 A1
(43) Pub. Date: May 26, 2016

(54) USB ESD PROTECTION CIRCUIT

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: XIN YE, Wuhan (CN); CHUN-SHENG CHEN, New Taipei (TW)

(21) Appl. No.: 14/587,637

(22) Filed: Dec. 31, 2014

(30) Foreign Application Priority Data
Nov. 26, 2014 (CN) 201410703430.X

(51) Int. Cl. H02H 9/04

(52) U.S. Cl. CPC H02H 9/04

(57) ABSTRACT

A circuit for USB protecting against electrostatic discharge includes a diode array, a zener diode, and a voltage protection circuit. The positive pole of the zener diode is grounded and coupled to a first terminal of the diode array. The negative pole of the zener diode is coupled to a second terminal and a first port of the voltage protection circuit. Two nodes of the diode array are coupled to a pair of data ports of a USB connector. A second port of the voltage protection circuit is coupled to a power port. When the power port has a low level of voltage and the first or second data port has a high level of voltage, the circuit switches off the connection between the diode array and the power port, preventing the low level of voltage from being changed to high level of voltage.

### FIELD

The subject matter herein generally relates to protective circuits.

### BACKGROUND

A universal serial bus (USB) electro-static discharge ESD protection circuit generally includes a diode array and a zener diode coupled to the diode array. A pair of data ports of a USB connector is coupled to two ports of the diode array. When each data port has a high voltage, such as +8 kv static, the static will reverse breakdown the zener diode and then be guided to ground. Generally, the positive pole of the zener diode is grounded. The negative pole of the zener diode is coupled to a power port of the USB connector, and the power port is coupled to a power supply of a motherboard of an electronic device.

### BRIEF DESCRIPTION OF THE DRAWINGS

Implementations of the present technology will now be described, by way of example only, with reference to the attached figures.

FIG. 1 is a circuit diagram of an embodiment of a USB ESD protection circuit in a computer mouse.

FIG. 2 is a circuit diagram of the USB ESD protection circuit of FIG. 1 coupled to a USB connector.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

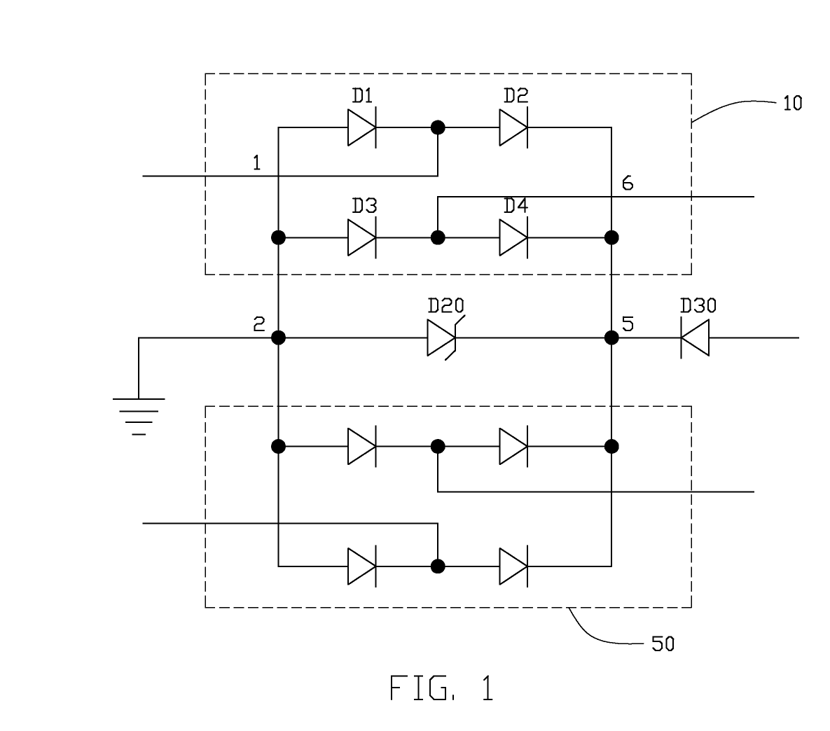

FIG. 1 illustrates a USB protection circuit configured to protect an electronic device from electrostatic discharge (a USB ESD protection circuit) in accordance with an embodiment. The USB ESD protection circuit can include a first diode array 10, a zener diode D20, and a voltage protection circuit D30.

The first diode array 10 can include a first diode D1, a second diode D2, a third diode D3, and a fourth diode D4. The positive pole of the first diode D1 is coupled to the positive pole of the third diode D3. The negative pole of the first diode D1 is coupled to the positive pole of the second diode D2. The negative pole of the second diode D2 is coupled to the negative pole of the fourth diode D4. The positive pole of the fourth diode D3 is coupled to the negative pole of the third diode D3.

The positive pole of the zener diode D20 is grounded and coupled to the positive poles of the third diode D3 and the first diode D1. The negative pole of the zener diode D20 is coupled to the negative poles of the second diode D2 and the fourth diode D4. The negative pole of the zener diode D20 is also coupled to the negative pole of the voltage protection circuit D30.

In at least one embodiment, the voltage protection circuit D30 is a diode.

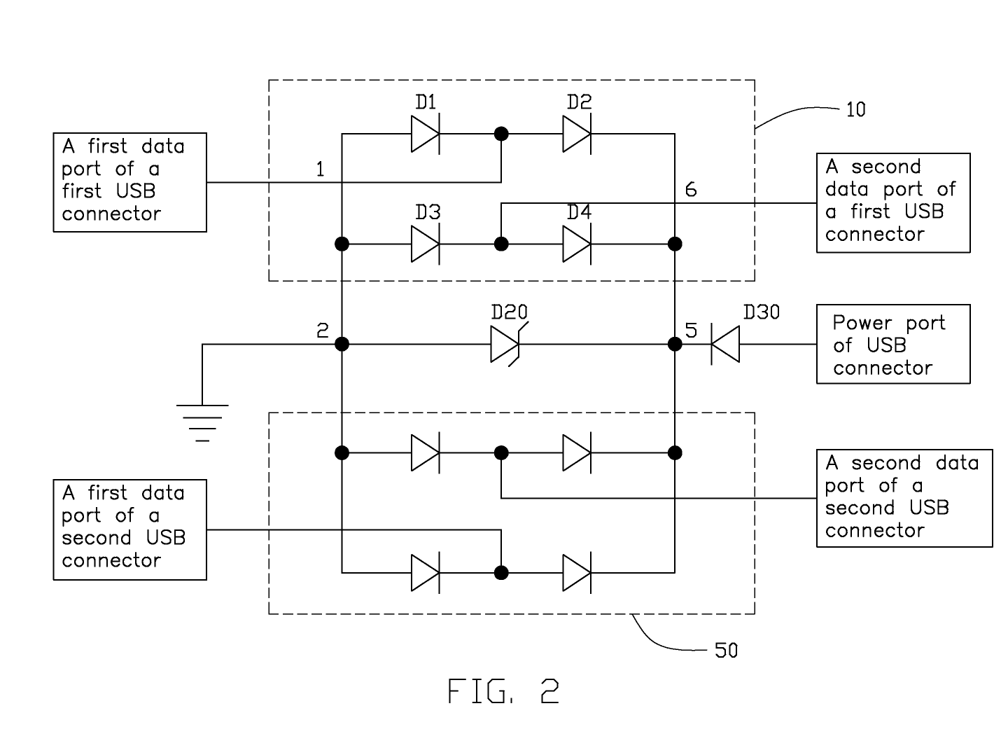

A node 1 (first data port) between the negative pole of the first diode D1 and the positive pole of the second diode D2 is coupled to a first data port of a USB connector (shown as in FIG. 2). A node 6 between the positive pole of the fourth diode D4 and the negative pole of the second diode D3 is coupled to a second data port of the USB connector. A node 2 (second data port) of the positive pole of the zener diode D20 is grounded. A node 5 of the negative pole of the voltage protection circuit D30 is coupled to a power port of the USB connector. The power port of the USB connector is coupled to a power supply output from a motherboard of the electronic device (not shown).

When the node 1 inputs a high positive static voltage, the second diode D2 is switched on, the high positive static voltage reverse breakdowns the zener diode D20 and is guided to the grounded. When the node 1 inputs a high negative static voltage, the first diode D1 is switched on, the high negative static voltage reverse breakdowns the zener diode D20 and is guided to the grounded. When the node 6 inputs a high positive static voltage, the fourth diode D4 is switched on, the high positive static voltage reverse breakdowns the zener diode D20 and is guided to the grounded. When the node 6 inputs a high negative static voltage, the third diode D3 is switched on, and the high negative static voltage reverse breakdowns the zener diode D20 and is guided to the grounded.

When the electronic device is in the dormant state (S4), the power port of the USB connector outputs a low level of voltage, so that the positive pole of the voltage protection circuit D30 is at low level of voltage. In this position, if the negative pole of the zener diode D20 is directly coupled to the power port, and the node 1 or 6 abnormally inputs a high level of voltage, the voltage of the power port will be changed to the high level of voltage from the low level of voltage, and the electronic device will be woken up from the dormant state, causing a power timing disorder in the electronic device.

In this embodiment, the negative pole of the zener diode D20 is coupled to the power port via the voltage protection circuit, thus when node 1 or 6 abnormally inputs a high level of voltage, the voltage protection circuit is switched off, preventing the power port from being changed to the high level of voltage, preventing the electronic device from being woken up from the dormant state. In at least one embodiment, the high level of voltage is 1.0V-2.5V.

The USB ESD protection circuit can further include a second diode array 50. The second diode array 50 has four diodes coupled in the same manner as the first diode array 10 and is coupled to the zener diode D20 as the first diode array 10. The second diode array 50 is configured to protect a second USB connector. Thus, the USB ESD protection circuit can protect two USB connectors.

The embodiments shown and described above are only examples. Many details are often found in the art such as the other features of a USB ESD protection circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A universal serial bus (USB) electro-static discharge (ESD) protection circuit comprising:
a first diode array;
a zener diode coupled to two terminals of the first diode array; and
a voltage protection circuit;
wherein the positive pole of the zener diode is grounded and coupled to a first terminal of the first diode array; the negative pole of the zener diode is coupled to a second terminal of the first diode array and a first port of the voltage protection circuit; two nodes of the first diode array are configured to couple to a pair of data ports of a USB connector; static in each data port is guide to the ground by the zener diode via the first diode array; and a second port of the voltage protection circuit is configured to couple to a power port of the USB connector; and
wherein when the power port has a low level of voltage and the first data port or the second data port has a high level of voltage, the voltage protection circuit switches off the connection between the first diode array and the power port, preventing the low level of voltage of the power port from being changed to the high level of voltage.

2. The USB ESD protection circuit of claim 1, wherein the voltage protection circuit is a diode.

3. The USB ESD protection circuit of claim 2, wherein the negative pole of the zener diode is coupled to the negative pole of the diode, and the positive pole of the diode is configured to couple to the power port.

4. The USB ESD protection circuit of claim 1, wherein the first diode array comprises a first diode, a second diode, a third diode, and a fourth diode, the positive pole of the first diode is coupled to the positive pole of the third diode, the negative pole of the first diode is coupled to the positive pole of the second diode, the negative pole of the second diode is coupled to the negative pole of the fourth diode, and the positive pole of the fourth diode is coupled to the negative pole of the third diode.

5. The USB ESD protection circuit of claim 4, wherein the positive pole of the zener diode is grounded and coupled to the positive poles of the third diode and the first diode, and the negative pole of the zener diode is coupled to the negative poles of the second diode and the fourth diode.

6. The USB ESD protection circuit of claim 5, wherein a node between the negative pole of the first diode and the positive pole of the second diode is coupled to the first data port of the USB connector, and a node between the positive pole of the fourth diode and the negative pole of the second diode is coupled to the second data port of the USB connector.

7. The USB ESD protection circuit of claim 1, wherein the power port is configured to couple to a power supply output from a motherboard of the electronic device, and the power port has a low level of voltage when the electronic device is in a dormant state.

8. The USB ESD protection circuit of claim 7, wherein the high level of voltage of each of the first data port and the second data port is a high level of voltage determined by the electronic device.

9. The USB ESD protection circuit of claim 8, wherein the high level of voltage is 1.0V-2.5V.

10. The USB ESD protection circuit of claim 1, further comprising a second diode array, wherein the second diode array has four diodes coupled the same as the first diode array and is coupled to the zener diode as the first diode array, and the second diode array is configured to protect another USB connector.

11. A universal serial bus (USB) electro-static discharge (ESD) protection circuit comprising:
a first diode array;
a second diode array;
a zener diode coupled to two terminals of each of the first diode array and the second diode array; and
a voltage protection circuit;
wherein the positive pole of the zener diode is grounded and coupled to a first terminal of the first diode array and the second diode array; the negative pole of the zener diode is coupled to a second terminal of the first diode array and the second diode array and a first port of the voltage protection circuit; two nodes of the first diode array are configured to couple to a pair of data ports of a first USB connector; two nodes of the second diode array are configured to couple to a pair of data ports of a second USB connector; static in each data port is guide to the ground by the zener diode; a second port of the voltage protection circuit is configured to couple to a power port of the USB connector or the second USB connector; and
wherein when the power port has a low level of voltage and each data port has a high level of voltage, the voltage protection circuit switches off the connection between the first and second diode arrays and the power port, preventing the low level of voltage of the power port from being changed to the high level of voltage.

12. The USB ESD protection circuit of claim 11, wherein the voltage protection circuit is a diode.

13. The USB ESD protection circuit of claim 12, wherein the negative pole of the zener diode is coupled to the negative pole of the diode, and the positive pole of the diode is configured to couple to the power port.

14. The USB ESD protection circuit of claim 11, wherein the first diode array comprises a first diode, a second diode, a third diode, and a fourth diode, the positive pole of the first diode is coupled to the positive pole of the third diode, the negative pole of the first diode is coupled to the positive pole of the second diode, the negative pole of the second diode is coupled to the negative pole of the fourth diode, and the positive pole of the fourth diode is coupled to the negative pole of the third diode.

15. The USB ESD protection circuit of claim 14, wherein the positive pole of the zener diode is grounded and coupled to the positive poles of the third diode and the first diode, and the negative pole of the zener diode is coupled to the negative poles of the second diode and the fourth diode.

16. The USB ESD protection circuit of claim 15, wherein a node between the negative pole of the first diode and the positive pole of the second diode is coupled to a first data port of the first USB connector, and a node between the positive pole of the fourth diode and the negative pole of the second diode is coupled to a second data port of the first USB connector.

17. The USB ESD protection circuit of claim 11, wherein the power port is configured to couple to a power supply output from a motherboard of the electronic device, and the power port has a low level of voltage when the electronic device is in a dormant state.

18. The USB ESD protection circuit of claim 17, wherein the high level of voltage of each of the first data port and the second data port is a high level of voltage determined by the electronic device.

19. The USB ESD protection circuit of claim 18, wherein the high level of voltage is 1.0V-2.5V.

20. A universal serial bus (USB) electro-static discharge (ESD) protection circuit comprising:
a first array of two or more diodes;
a zener diode having a positive pole and a negative pole; and
a voltage protection circuit with a first port and a second port;
wherein, the positive pole of the zener diode is grounded and is connected to a first terminal of the first array, and the negative pole of the zener diode is connected coupled to the second terminal of the first array and the first port of the voltage protection circuit;
wherein, the first array includes a first data port and a second data port, with the first data port and the second data port being connectable to data ports of a USB connector;
wherein, the zener diode and the first array grounds any electro-static discharge from the first data port or the second data port;
wherein, the second port of the voltage protection circuit is connectable to a power port of the USB connector; and
wherein, the voltage protection circuit disconnects the first array from the USB power port if;
low voltage is detected in the USB power port and the first data port has a high level of voltage; or
low voltage is detected in the USB power port and the second data port has a high level of voltage.
